(19) United States
(12) Patent Application Publication
(10) Pub. No.: US 2014/0002226 A1
(43) Pub. Date: Jan. 2, 2014

(54) INDUCTOR AND METHOD OF MANUFACTURING THE SAME

(71) Applicant: SAMSUNG ELECTRO-MECHANICS CO., LTD., Suwon (KR)

(72) Inventors: Jin Seok Moon, Suwon (KR); Sung Kwon Wi, Suwon (KR); Jeong Kyu Lee, Suwon (KR); Keun Yong Lee, Suwon (KR); Hyun Jun Lee, Suwon (KR); Seong Hyun Yoo, Suwon (KR)

(73) Assignee: SAMSUNG ELECTRO-MECHANICS CO., LTD., Suwon (KR)

(21) Appl. No.: 13/873,038

(22) Filed: Apr. 29, 2013

(30) Foreign Application Priority Data
Jun. 29, 2012 (KR) 10-2012-0070824

(51) Int. Cl. H01F 41/12; H01F 27/00

(52) U.S. Cl. CPC H01F 41/125; H01F 27/00
USPC 336/200; 216/18

(57) ABSTRACT

Disclosed herein are an inductor and a method of manufacturing the same. More specifically, in the inductor according to the present invention, a coil with a fine pattern may be formed, and an insulating resin composite including liquid crystal oligomer for reducing occurrence of deformation of the coil may be used for an insulating substrate.

### CROSS REFERENCE TO RELATED APPLICATION

This application claims the benefit of Korean Patent Application No. 10-2012-0070824, filed on Jun. 29, 2012, entitled “Inductor and Method of Manufacturing The Same”, which is hereby incorporated by reference in its entirety into this application.

### BACKGROUND OF THE INVENTION

1. Technical Field

The present invention relates to an inductor and a method of manufacturing the same.

2. Description of the Related Art

With the development of miniaturization and complex functionalization of mobile devices, demands for micro-miniaturization of electronic components have increased, and electrical, thermal, and mechanical characteristics of electronic materials may be exerted as important elements. An inductor is one of the important passive devices composed of an electronic circuit together with a resistor and a capacitor, and used as a component that eliminates noise or includes an LC resonator circuit.

In the prior art, a component such as an inductor has been manufactured using a ceramic material due to electrical characteristics such as high dielectric constant, inductance, or the like, and characteristics such as low thermal expansion coefficient, high strength, or the like, but there arise problems that deformation of a coil easily occurs by smearing of an electrode in a printing process, or alignment deviation or a pressed electrode at the time of laminating and pressing, and deformation of a coil shape develops too much due to contractive deformation at the time of firing. Therefore, accuracy of the inductance in a high frequency region may be reduced, and it may be difficult to reduce a size of the inductor and achieve high-frequency due to low Q characteristics.

Meanwhile, as disclosed in Patent Document 1, in order to further increase inductance of the entire coil, a conductor pattern and an insulating layer are more multi-layered to thereby obtain a high inductance value. However, in the multi-layered form, an overall thickness of a lamination is increased, and excellent Q characteristics are not realized due to contractive deformation or the like in a firing process.

Therefore, in the present invention, a coil pattern is formed without causing any problems when forming an electrode while having thermal, electrical, and mechanical characteristics similar to those of the existing ceramic material, and availability liquid crystal oligomer (LOC) capable of improving a Q-factor in a high-frequency region is applied as an insulating layer of the inductor to thereby cope with miniaturization and realization of high-frequency of a variety of mobile devices, an RF module, and the like.

### PRIOR ART DOCUMENT

### Patent Document

(Patent Document 1) Korean Patent Laid-Open Publication No. 2006-0009302

### SUMMARY OF THE INVENTION

The present invention has been made in an effort to provide an inductor with a low dielectric loss and an improved Q-factor.

Further, the present invention has been made in an effort to provide a method of manufacturing an inductor that is manufactured through the insulating substrate, and therefore a fine pattern may be formed, and the inductor with less deformation of a coil may be manufactured without requiring a firing process.

According to an embodiment of the present invention, there is provided an inductor including: a chip main body that includes an insulating substrate, and a laminate in which a plurality of conductor patterns and insulating layers are alternately laminated on the insulating substrate, the laminate having a single coil in which the plurality of conductor patterns are connected to each other in series in the laminated direction thereof; and a pair of external connection electrodes that are respectively provided on both side cross-sections of the chip main body, and in which an end of the single coil is connected to one of the pair of external connection electrodes and the other end thereof is connected to the other of the pair of external connection electrodes. Here, the insulating substrate may be composed of an insulating epoxy resin composite including liquid crystal oligomer represented by the following Chemical Formula 1, epoxy resin, a hardener, and an inorganic filler.

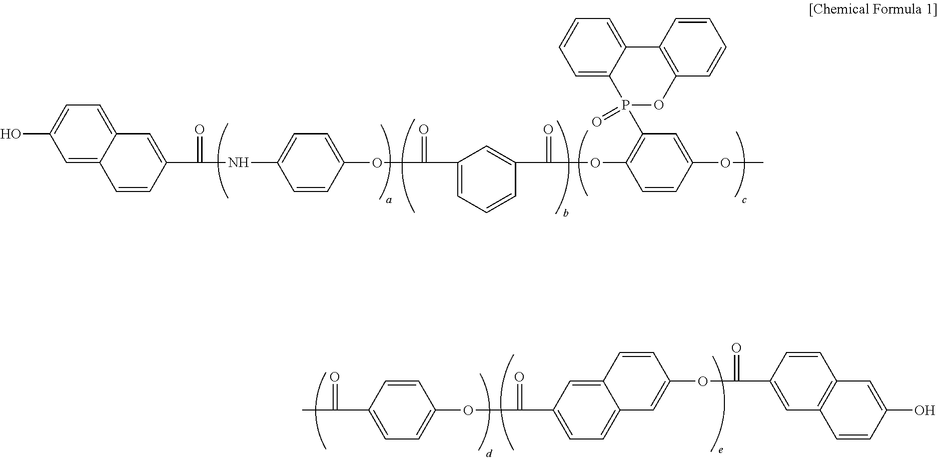

In Chemical Formula 1, a, b, c, d, and e may be the same or different integers of 1 to 100, and 4≦a+c+d+e≦103 may be satisfied.

In the inductor according to the present invention, the insulating layer may be composed of the insulating epoxy resin composite including the liquid crystal oligomer represented by the following Chemical Formula 1, the epoxy resin, the hardener, and the inorganic filler.

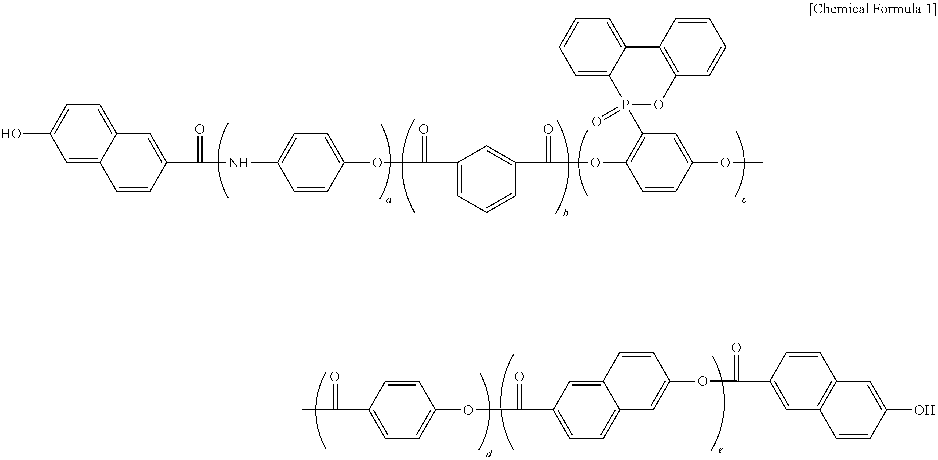

In Chemical Formula 1, a, b, c, d, and e may be the same or different integers of 1 to 100, and 4≦a+c+d+e≦103 may be satisfied.

In the inductor according to the present invention, a number average molecular weight of the liquid crystal oligomer may be 2,500 to 6,500, and a molar ratio of amide in the liquid crystal oligomer may be 12 to 30 mol %.

In the inductor according to the present invention, the insulating resin composite may include 10 to 30 weight % of the liquid crystal oligomer, 5 to 20 weight % of the epoxy resin, 0.05 to 0.2 weight % of the hardener, and 50 to 80 weight % of the inorganic filler.

In the inductor according to the present invention, the epoxy resin may be bisphenol-F type epoxy resin represented by the following chemical formula 2.

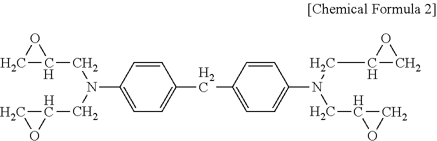 [SMILES: c1cc(N(CC2CO2)CC2CO2)ccc1Cc1ccc(N(CC2CO2)CC2CO2)cc1]

In the inductor according to the present invention, the hardener may be dicyanamide.

In the inductor according to the present invention, the inorganic filler may be one or more selected from a group of silica, alumina, barium sulfate, talc, clay, mica powder, aluminum hydroxide, magnesium hydroxide, calcium carbonate, magnesium carbonate, magnesium oxide, boron nitride, boric-acid aluminum, barium titanate, calcium titanate, magnesium titanate, bismuth titanate, titanium oxide, barium zirconate, and calcium zirconate.

In the inductor according to the present invention, the insulating epoxy resin composite may further include one or more components selected from a group consisting of a hardening accelerator, a leveling agent, and a flame retardant.

According to another embodiment of the present invention, there is provided a method (hereinafter, referred to as a “first method”) of manufacturing an inductor, including: providing an insulating substrate formed of an insulating epoxy resin composite that includes liquid crystal oligomer represented by the following chemical formula 1, epoxy resin, a hardener, and an inorganic filler; hardening the insulating substrate by forming a copper foil on both side surfaces of the insulating substrate; removing the copper foil at one side surface of the insulating substrate; forming a photoresist layer on the copper foil of the other side surface of the insulating substrate, exposing and developing the formed photoresist layer in the form of a first conductor pattern, electrolytically plating the exposed and developed photoresist layer, and removing the remaining photoresist layer and copper foil to thereby form the first conductor pattern; forming a first insulating layer on the first conductor pattern, and forming a via-hole; forming a seed layer electrically connected through the via-hole formed on the first insulating layer; forming a photoresist layer on the seed layer, exposing and developing the formed photoresist layer in the form of a second conductor pattern, electrolytically plating the exposed and developed photoresist layer, and removing the remaining photoresist layer and copper foil to thereby form the second conductor pattern; manufacturing a chip main body by forming a second insulating layer on the second conductor pattern; and providing a pair of external connection electrodes that are respectively provided on both side cross-sections of the chip main body, and in which an end of a single coil is connected to one of the pair of external connection electrodes and the other end thereof is connected to the other of the pair of external connection electrodes.

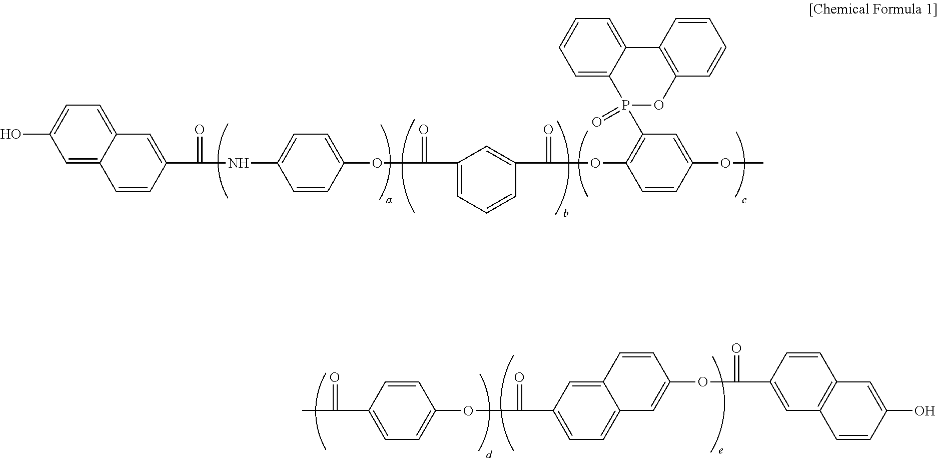

In Chemical Formula 1, a, b, c, d, and e may be the same or different integers of 1 to 100, and 4≦a+c+d+e≦103 may be satisfied.

According to still another embodiment of the present invention, there is provided a method (hereinafter, referred to as a “second method”) of manufacturing an inductor, including: providing an insulating substrate formed of an insulating epoxy resin composite that includes liquid crystal oligomer represented by the following chemical formula 1, epoxy resin, a hardener, and an inorganic filler; hardening the insulating substrate by forming a copper foil on both side surfaces of the insulating substrate; removing the copper foil at the both side surfaces of the insulating substrate; forming a first seed layer on one side surface of the insulating substrate; forming a photoresist layer on the first seed layer, exposing and developing the formed photoresist layer in the form of a first conductor pattern, electrolytically plating the exposed and developed photoresist layer, and removing the remaining photoresist layer and copper foil to thereby form the first conductor pattern; forming a first insulating layer on the first conductor pattern, and forming a via-hole; forming a second seed layer electrically connected through the via-hole formed on the first insulating layer; forming a photoresist layer on the second seed layer, exposing and developing the formed photoresist layer in the form of a second conductor pattern, electrolytically plating the exposed and developed photoresist layer, and removing the remaining photoresist layer and copper foil to thereby form the second conductor pattern; manufacturing a chip main body by forming a second insulating layer on the second conductor pattern; and providing a pair of external connection electrodes that are respectively provided on both side cross-sections of the chip main body, and in which an end of a single coil is connected to one of the pair of external connection electrodes and the other end thereof is connected to the other of the pair of external connection electrodes.

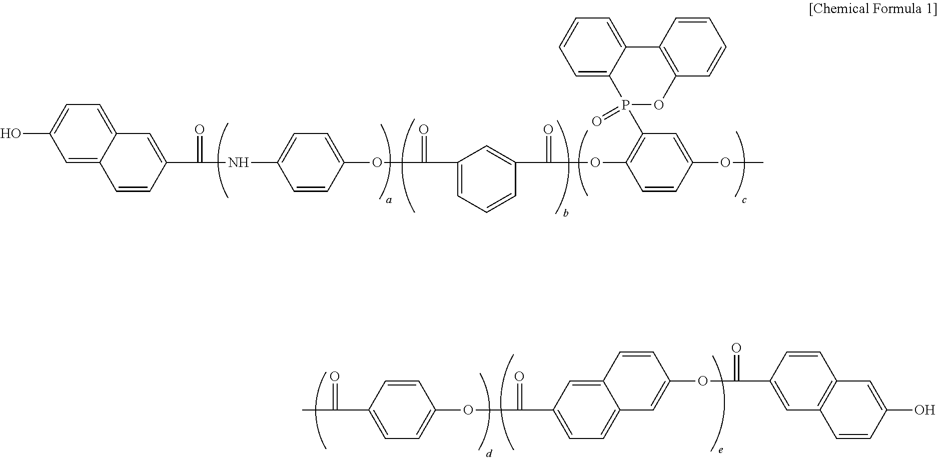

In Chemical Formula 1, a, b, c, d, and e may be the same or different integers of 1 to 100, and 4≦a+c+d+e≦103 may be satisfied.

In the first and second methods according to the present invention, the insulating layer may be formed of the insulating epoxy resin composite including the liquid crystal oligomer represented by the following chemical formula 1, the epoxy resin, the hardener, and the inorganic filler (hereinafter, referred to as a “third method”).

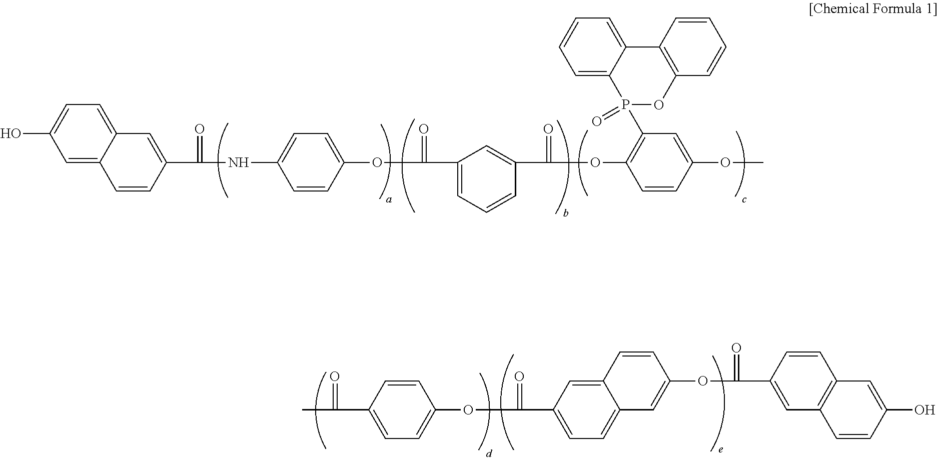

In Chemical Formula 1, a, b, c, d, and e may be the same or different integers of 1 to 100, and 4≦a+c+d+e≦103 may be satisfied.

In the first and second methods according to the present invention, a number average molecular weight of the liquid crystal oligomer may be 2,500 to 6,500, and a molar ratio of amide in the liquid crystal oligomer may be 12 to 30 mol %.

In the first and second methods according to the present invention, the insulating resin composite may include 10 to 30 weight % of the liquid crystal oligomer, 5 to 20 weight % of the epoxy resin, 0.05 to 0.2 weight % of the hardener, and 50 to 80 weight % of the inorganic filler.

In the first and second methods according to the present invention, the epoxy resin may be bisphenol-F type epoxy resin represented by the following chemical formula 2.

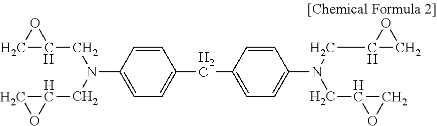 [SMILES: c1cc(N(CC2CO2)CC2CO2)ccc1Cc1ccc(N(CC2CO2)CC2CO2)cc1]

In the third method according to the present invention, the insulating resin composite may include 10 to 30 weight % of the liquid crystal oligomer, 5 to 20 weight % of the epoxy resin, 0.05 to 0.2 weight % of the hardener, and 50 to 80 weight % of the inorganic filler.

In the first and second methods according to the present invention, the insulating substrate may be formed in such a manner that the insulating epoxy resin composite is impregnated with glass fiber.

### BRIEF DESCRIPTION OF THE DRAWINGS

The above and other objects, features, and advantages of the present invention will be more clearly understood from the following detailed description taken in conjunction with the accompanying drawings, in which:

FIGS. 1A to 1G are processing diagrams showing a process of manufacturing an inductor using an insulating substrate in which a copper foil is etched on a surface thereof according to an embodiment of the present invention; and

FIGS. 2A to 2H are processing diagrams showing a process of manufacturing an inductor using an insulating substrate in which a copper foil is respectively etched on both surface thereof according to an embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms.

Hereinafter, preferred embodiments of the present invention will be described in detail with reference to the attached drawings.

In general, an inductor may include a chip main body that includes an insulating substrate, and a laminate in which a plurality of conductor patterns and insulating layers are alternately laminated on the insulating substrate, the laminate having a single coil in which the plurality of conductor patterns are connected to each other in series in the laminated direction thereof, and a pair of external connection electrodes that are respectively provided on both side cross-sections of the chip body, and in which an end of the single coil is connected to one of the pair of external connection electrodes and the other end thereof is connected to the other of the pair of external connection electrodes.

In the present invention, to improve dielectric characteristics of the inductor and a Q-factor, the insulating substrate and/or the insulating layer is composed of an insulating epoxy resin composite including liquid crystal oligomer (A) represented by the following chemical formula 1, epoxy resin (B), a hardener (C), and an inorganic filler (D).

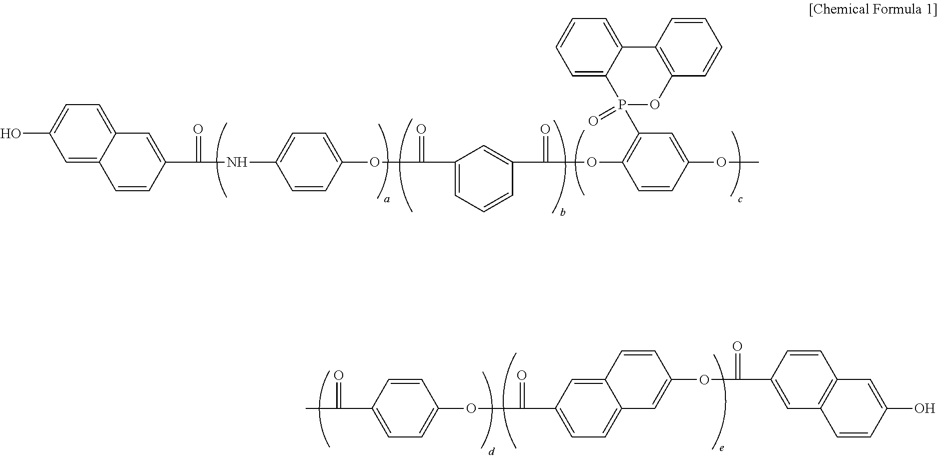

Here, a, b, c, d, and e are the same or different integers of 1 to 100, and 4≦a+c+d+e≦103 is satisfied.

The liquid crystal oligomer represented by Chemical Formula 1 contains phosphorus for imparting flame retardancy, and contains a naphthalene group for crystallizability. It is desirable that a material used for the insulating substrate of the inductor has a low dielectric loss. Here, compared to that a ceramic substrate used as the insulating substrate in the related art has a dielectric loss value of 0.01 or less, the liquid crystal oligomer of the present invention has a dielectric loss value of 0.005 or less.

In this manner, the insulating resin composite containing the liquid crystal oligomer having the dielectric loss value of 0.005 or less is used for the insulating substrate, and therefore a coil with a fine pattern may be formed because a thermal expansion coefficient is low while a dielectric tangent and a dielectric constant are low. In addition, deformation of the coil does not occur due to smearing of an electrode in a printing process, or alignment deviation or a pressed electrode at the time of laminating and pressing, and nor does deformation of a coil occur due to contractive deformation at the time of firing because a firing process is not required. Therefore, a Q-factor may be improved, and an inductor having small variation of the value of the inductance may be manufactured.

According to the present invention, a number average molecular weight of the liquid crystal oligomer is preferably 2,500 g/mol to 6,500 g/mol, and more preferably, 3,500 g/mol to 5,000 g/mol. When the number average molecular weight of the liquid crystal oligomer is less than 2,500 g/mol, mechanical property is weak, and when the number average molecular weight exceeds 6,500 g/mol, solubility is reduced.

In addition, a molar ratio of amide in the molecule of the liquid crystal oligomer is preferably 12 to 30 mol %, and more preferably, 15 to 25 mol %. When the molar ratio of amide in the molecule of the liquid crystal oligomer is less than 12 mol %, solubility is reduced, and when the molar ratio thereof exceeds 30 mol %, hygroscopic property may be increased.

A used amount of the liquid crystal oligomer is preferably 10 to 30 weight %, and more preferably 13 to 20 weight %. When the used amount is less than 10 weight %, a dielectric tangent and a dielectric constant are not greatly improved, and when the used amount exceeds 30 weight %, mechanical property may be reduced.

The resin composite according to the present invention includes epoxy resin to enhance handling property of the resin composite after drying. The epoxy resin is not particularly limited, but at least one epoxy group should be included in the molecule, preferably at least two epoxy groups, and more preferably at least four epoxy groups.

As the epoxy resin usable in the present invention, bisphenol A type epoxy resin, bisphenol-F type epoxy resin, bisphenol-S type epoxy resin, phenol novolac type epoxy resin, alkyl phenol novolac type epoxy resin, biphenyl type epoxy resin, aralkyl-type epoxy resin, dicyclopentadiene epoxy resin, naphthalene type epoxy resin, naphthol-type epoxy resin, epoxy resin of a condensate with aromatic aldehydes having phenols and phenolic hydroxyl group, biphenyl aralkyl-type type epoxy resin, fluorene-type epoxy resin, xanthenes-type epoxy resin, triglycidylisocyanurate, rubber-modified epoxy resin, phosphorous epoxy resin, or the like may be used, and bisphenol-F type epoxy resin in which an epoxy group represented by the following Chemical Formula 2 is 4 is preferable.

In the present invention, one or two more kinds of the epoxy resin may be mixed to be used.

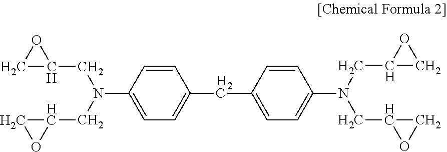

A used amount of the epoxy resin is preferably 5 to 20 weight %. Here, when the used amount is less than 5 weight %, handling property is deteriorated, and when the used amount exceeds 20 weight %, an added amount of other ingredients is relatively reduced, and therefore a dielectric tangent, a dielectric constant, and a thermal expansion coefficient are limitedly improved.

Meanwhile, the hardener used in the present invention is not particularly limited as long as the hardener can be typically used for heat-curing the epoxy resin. Specifically, amide-based hardener such as dicyanamide; diethylenetriamine as polyamine based hardener, triethylenetetramine, N-aminoethyl piperazine, diamino diphenyl methane, adipic acid dihydrazide, and the like; pyro metal acid anhydride as acid anhydride hardener, benzophenonetetracarboxylic dianhydride, ethylene glycol bis trimethylic anhydride, glycerol tris-trimellitate anhydride, maleicmethylcyclohexene tetrabasic acid anhydride, and the like; phenol novolac hardener, trioxane triethylene mercaptan, and the like as poly mercaptan hardener; benzyl dimethyl amine as tertiary amine compounds, 2,4,6-tris(dimethylaminomethyl) phenol, and the like; 2-ethyl-4-methyl imidazole, 2-methyl imidazole, 1-benzyl-2-methyl imidazole, 2-heptadecyl imidazole, 2-undecyl imidazole, 2-phenyl-4-methyl-5-hydroxymethyl imidazole, 2-phenyl imidazole, 2-phenyl-4-methyl-imidazole, 1-benzyl-2-phenyl imidazole, 1,2-dimethyl imidazole, 1-cyanoethyl-2-phenyl imidazole, 2-phenyl-4,5-dihydroxymethyl imidazole as imidazole compounds may be used, and dicyanamide is preferably used due to property.

A used amount of the hardener is preferably 0.05 to 0.2 weight %. Here, when the used amount of the hardener is less than 0.05 weight %, a hardening rate is reduced, and when the used amount exceeds 0.2 weight %, an unreacted hardener may exist, and moisture absorptivity of the insulating substrate and/or the insulating layer is increased resulting in a reduction in electrical characteristics.

The resin composite according to the present invention contains an inorganic filler to reduce a thermal expansion coefficient (CTE) of the insulating resin. The inorganic filler is used to reduce the thermal expansion coefficient, and the content of the inorganic filler differs depending on required characteristics based on application or the like of the resin composite but is preferably 50 to 80 weight % based on the resin composite. When the content of the inorganic filler is less than 50 weight %, a dielectric tangent is reduced and a thermal expansion coefficient is increased, and when the content exceeds 80 weight %, an adhesive strength is reduced. More preferably, the content of the inorganic filler is greater than 60 weight % based on a solid portion of the entire resin composite.

As the inorganic filler used in the present invention, one or more selected from a group of silica, alumina, barium sulfate, talc, clay, mica powder, aluminum hydroxide, magnesium hydroxide, calcium carbonate, magnesium carbonate, magnesium oxide, boron nitride, boric-acid aluminum, barium titanate, calcium titanate, magnesium titanate, bismuth titanate, titanium oxide, barium zirconate, and calcium zirconate may be combined to be used. In particular, silica with a low dielectric tangent is preferably used.

In addition, when an average diameter of the inorganic filler exceeds 5 μm, it is difficult to stably form a fine pattern when a circuit pattern is formed on a conductor layer, and therefore it is preferable that the average diameter thereof is less than 5 μm. In addition, to improve moisture resistance, it is preferable that the inorganic filler is required to be subjected to surface treatment using a surface treating agent such as a silane coupling agent or the like. More preferably, silica having a diameter of 0.2 to 2 μm is used.

The resin composite of the present invention contains a hardening accelerator, and thereby may be effectively hardened. As the hardening accelerator used in the present invention, a metallic hardening accelerator, an imidazole-based hardening accelerator, an amine-based hardening accelerator, or the like may be used, and one or two kinds of these are combined to be used.

The metallic hardening accelerator is not particularly limited, but an organometallic complex of metals such as cobalt, copper, zinc, iron, nickel, manganese, tin, and the like, or an organic metal salt may be used as the metallic hardening accelerator. As specific examples of the organometallic complexes, an organic cobalt complex such as cobalt (II) acetylacetonate or cobalt (III) acetylacetonate, an organic copper complex such as copper (II) acetylacetonate, an organic zinc complex such as zinc (II) acetylacetonate, an organic iron complex such as iron (III) acetylacetonate, an organic nickel complex such as nickel (II) acetylacetonate, an organic manganese complex such as manganese (II) acetylacetonate, or the like may be given. As examples of the organic metal salt, octyl acid zinc, octyl acid tin, zinc naphthenate, cobalt naphthenate, stearic acid tin, stearic acid zinc, or the like may be given. As examples of the metallic hardening accelerator, cobalt (II) acetylacetonate, cobalt (III) acetylacetonate, zinc (II) acetylacetonate, zinc naphthenate, or iron (III) acetylacetonate is preferably given in terms of hardness and solvent solubility, and particularly, cobalt (II) acetylacetonate and zinc naphthenate are preferably used. One or two kinds of the metallic hardening accelerator may be combined to be used. The imidazole-based hardening accelerator is not particularly limited, but as examples of the imidazole-based hardening accelerator, 2-methyl imidazole, 2-undecyl imidazole, 2-heptadecyl imidazole, 1,2-dimethyl imidazole, 2-ethyl-4-methyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-cyanoethyl-2-methyl imidazole, 1-cyanoethyl-2-undecyl imidazole, 1-cyanoethyl-2-ethyl-4-methyl imidazole, 1-cyanoethyl-2-phenyl imidazole, 1-cyanoethyl-2-undecyl imidazolium-trimellitate, 1-cyanoethyl-2-phenyl imidazolium-trimellitate, 2,4-diamino-6-[2′-methylimidazolyl-(1′)]-ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, 2,4-diamino-6-[2′-methyl imidazolyl-(1′)]-ethyl-s-triazine isocyanuric acid adduct, 2-phenyl imidazole isocyanuric acid adduct, 2-phenyl-4,5-dihydroxymethyl imidazole, 2-phenyl-4-methyl-5-hydroxymethyl imidazole, 2,3-dihydroxy-1H-pyrrolo[1,2-a]benzimidazole, 1-dodecyl-2-methyl-3-benzylimidazolelium chloride, an imidazole compound such as 2-methylimidazoline or 2-phenylimidazoline, an adduct body of epoxy resin may be given. One or two kinds of the imidazole hardening accelerator may be combined to be used.

The amine-based hardening accelerator is not particularly limited, but as examples of the amine-based hardening accelerator, trialkyl amine such as triethylamine or tributhylamine, amine compounds such as 4-dimethylaminopyridin, benzyldimethylamine, 2,4,6-tri(dimethylaminomethyl) phenol, 1,8-diazabicyclo (5,4,0)-undecene (hereinafter, referred to as “DBU”), or the like may be given. One or two kinds of the amine-based hardening accelerator may be combined to be used.

The insulating resin composite of the present invention is mixed in the presence of an organic solvent. As the organic solvent, considering solubility and miscibility of the resin and other additives used in the present invention, 2-methoxy-ethanol, acetone, methyl ethyl ketone, cyclohexanone, ethyl acetate, butyl acetate, cellosolve acetate, propylene glycol monomethyl ether acetate, ethylene glycol monobutyl ether acetate, cellosolve, butyl cellosolve, carbitol, butyl carbitol, xylene, dimethylformamide, and dimethylacetamide may be used, but the organic solvent of the present invention is not limited thereto.

Other than these, the present invention is not limited thereto, and may further include other leveling agents and/or flame retardants which are known, as necessary, by a person with ordinary skill in the art within the technical idea of the present invention.

Meanwhile, a method of manufacturing the inductor according to the present invention is as follows.

The insulating epoxy resin composite including the liquid crystal oligomer represented by Chemical Formula 1, epoxy resin, a hardener, an inorganic filler is used as an insulating material, a coil pattern is formed on a substrate in which one or both surfaces of Cu in an insulating body in a Cu clad laminate scheme are removed, a via-hole is processed to be connected for inter connection between layers. As a lead line connected to an external electrode, a conductive material, a metallic material such as Cu, Ag, Au, Al, or Ni, or an alloy material of these may be used.

In a substrate in which a Cu layer is formed on one layer, the Cu layer (about 2 μm) is used as a seed layer, and a thin seed layer is formed on the substrate in which Cu is removed from both surfaces. The seed layer is coated with photoresist (PR), an internal coil pattern is formed by Cu electroplating, and then PR is removed to be subjected to soft etching, thereby obtaining an internal coil.

On the internal coil, an insulating layer (a passivation layer) is formed using an insulating material. This process is repeated at least twice to thereby form the internal coil and the insulating layer, and then the internal coil and the insulating layer are connected with the external electrode to thereby manufacture the inductor of the present invention.

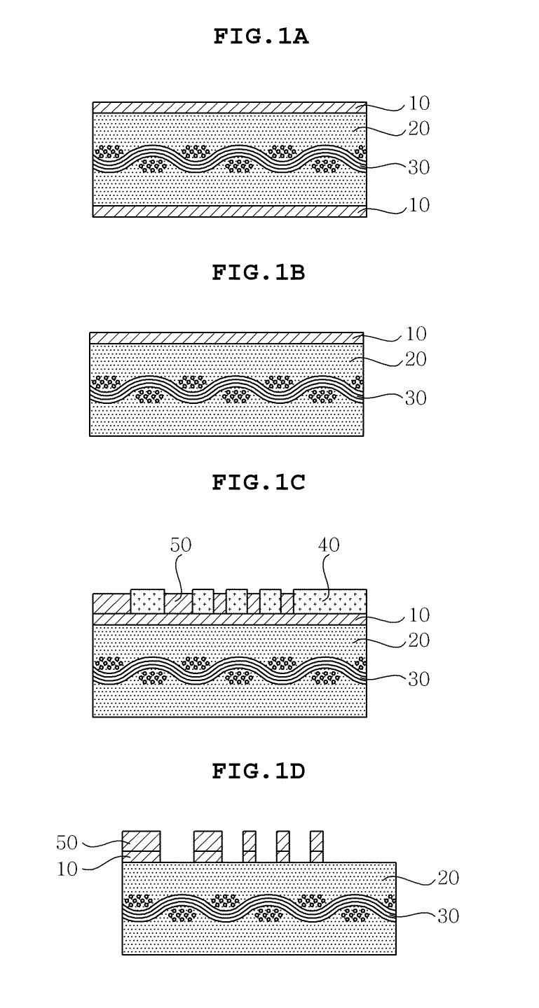

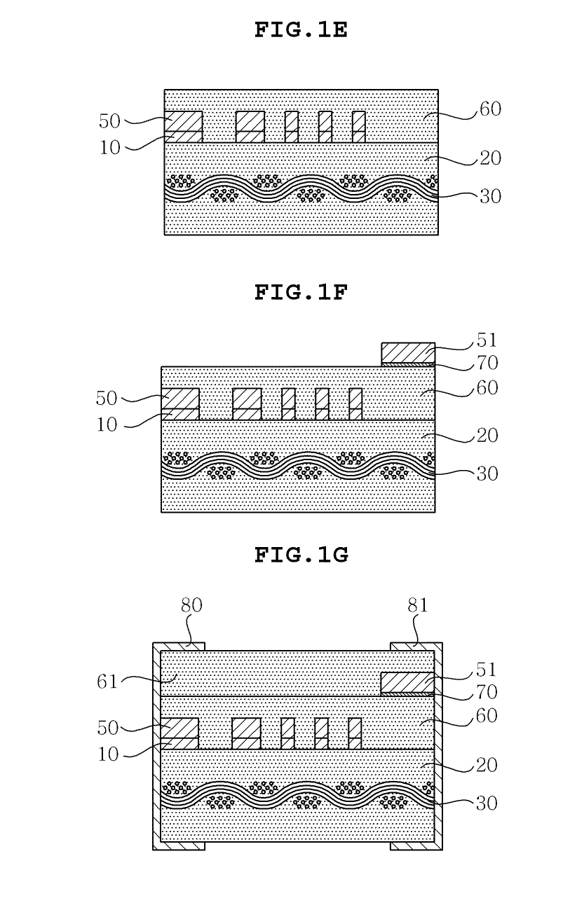

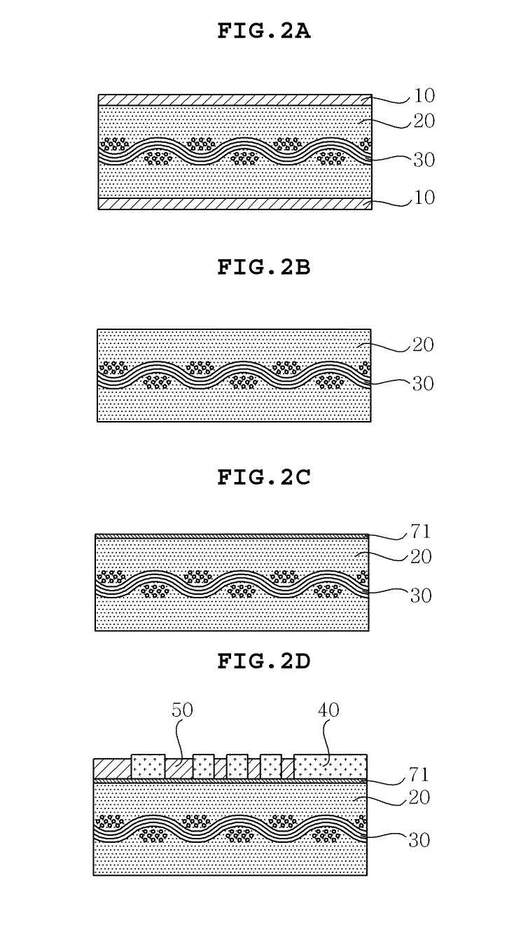

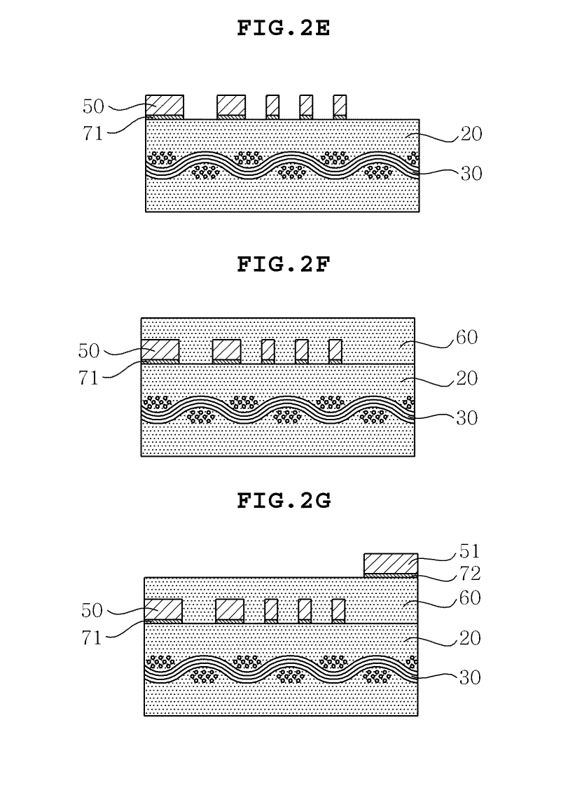

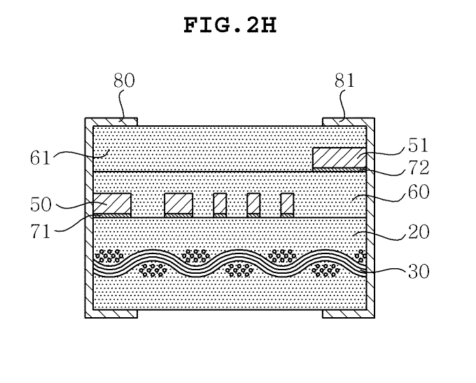

Referring to FIGS. 1 and 2, more specifically, a copper foil 10 is respectively formed on both surfaces of the insulating substrate 20 using the insulating epoxy resin composite according to the present invention, and this is to maintain a shape of the insulating substrate 20 through the copper foil 10 in a process of hardening the substrate. In addition, the insulating substrate 20 may be manufactured in such a manner that the insulating epoxy resin composite including the liquid crystal oligomer represented by Chemical Formula 1, the epoxy resin, the hardener, and the inorganic filler is impregnated with glass fiber.

One or both surfaces of the insulating substrate 20 with the copper foil 10 respectively formed on both surfaces thereof are etched, and then the copper foil 10 of one surface or both surfaces is removed. FIG. 1 shows a case in which the copper foil 10 is formed on one surface of the insulating substrate 20, and FIG. 2 shows a case in which the copper foil 10 is all removed. Next, in the insulating substrate 20 with the copper foil 10 formed on the other surface thereof, the copper foil 10 is used as a seed layer, and in the insulating substrate whose both surfaces are etched, the seed layers 71 and 72 are formed by a sputtering method using Cu, Ni, Ti, or alloy of these. Before forming the seed layers 70, 71, and 72, the insulating substrate 20 and the insulating layer 60 are subjected to dry surface treatment using plasma treatment, or wet surface treatment using chemical etching in order to improve adhesion between the insulating substrate 20 and the insulating layer 60, thereby forming the roughness on a surface of the insulating substrate. Next, a photoresist layer 40 is formed on the seed layer in the form of a conductor pattern, is exposed and developed, and the conductor pattern is formed through Cu electroplating. Next, the photoresist is removed through etching, and the copper foil 10 is subjected to micro-etching or soft-etching to thereby complete a first conductor pattern.

A first insulating layer 60 is formed on the first conductor pattern through passivation using an insulating material, and the insulating material may be the insulating epoxy resin composite according to the present invention, or ceramic or other polymeric materials. Next, for electrical connection between the first conductor pattern 50 and a second conductor pattern 51 which will be formed later, a via-hole or a through-hole (not shown) is formed on the insulating layer 60 to thereby form a via electrode.

The seed layers 70 and 72 are formed in a sputtering method or the like on the insulating layer 60 on which the via-hole or the through-hole is formed, the photoresist layer (not shown) is formed on the seed layer in the form of the conductor pattern, the photoresist layer is exposed and developed, and then the conductor pattern is formed through Cu electroplating. Next, the photoresist (not shown) is removed through etching, and the seed layers 70 and 72 is subjected to micro-etching or soft etching to thereby complete the second conductor pattern 51. Next, a second insulating layer 61 is formed on the second conductor pattern 51 through passivation using an insulating material. In this manner, the insulating substrate 20, the first conductor pattern 50, the first insulating layer 60, the second conductor pattern 51, a first external electrode 80 that wraps one side surface of both side surfaces of the second insulating layer 61 and a second external electrode 81 that wraps the other side surface are formed to thereby manufacture the inductor.

As described above, in the inductor according to the present invention, a coil of a fine pattern may be formed using the insulating resin composite including polyester-based availability liquid crystal oligomer (LCO) for the insulating substrate, and deformation of the coil does not occur due to smearing of an electrode in a printing process, or alignment deviation or a pressed electrode at the time of laminating and pressing, and nor does deformation of a coil shape occur due to contractive deformation at the time of firing because a firing process is not required. Therefore, stray capacity may be reduced to improve a Q-factor. In addition, since fluctuation and dispersion of inductance values are improved, the inductor having small variation may be effectively manufactured.

Hereinafter, the present invention will be described in detail through a preparation example and examples, but is not limited to the following examples.

### Preparation Example

### Preparation of Liquid Crystal Oligomer

4-aminophenol (2.0 mol), isophthalic acid (2.5 mol), 4-hydroxy benzoic acid (2.0 mol), 6-hydroxy-2-naphthoix acid (1.5 mol), and acetic anhydride (15 mol) were added to a reactor. An inside of the reactor is sufficiently substituted with a nitrogen gas, a temperature in the reactor rose to about 230° C. under a flow of nitrogen gas, and then the inside of the reactor was refluxed for about 4 hours while maintaining the temperature in the reactor at 230° C. Next, 6-hydroxy-2-naphthoic acid (1.0 mol) for distal end capping was additionally added, and acetic acid which was reaction by-products and unreacted acetic anhydride were removed, thereby preparing the liquid crystal oligomer represented by Chemical Formula 1.

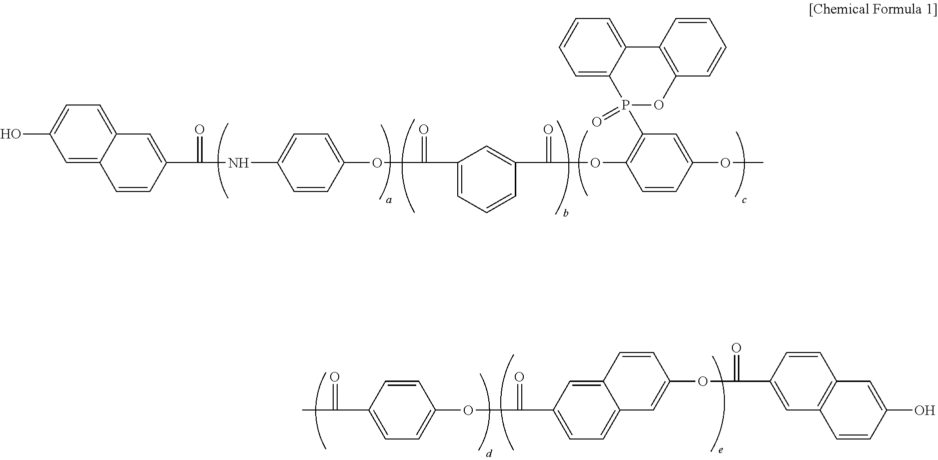

### Example 1

Silica having an average particle size of 0.2 μm to 1 μm was dispersed in 2-methoxy ethanol, thereby preparing a silica slurry having a concentration of 70 weight %. Next, 15.8 weight % of bisphenol F-type epoxy resin represented by Chemical Formula 2 was added to the prepared silica slurry (the content of silica being 60 weight %), and then the silica slurry was agitated at 300 rpm using an agitator at room temperature to thereby be dissolved, thereby preparing a mixture.

Next, 0.2 weight % of dicyan diamide and 24 weight % of the liquid crystal oligomer obtained in the preparation example 1, which was dissolved in dimethylacetamide, were added to the mixture, and was agitated at 300 rpm for further 1 hour. Next, 3 g of 2-ethyl-4-methyl imidazole and a leveling agent (BYK-337) were added with 1.5 PHR (Parts per Hundred parts of Resin) of the entire mixture, and then was agitated for 1 hour, thereby preparing an insulating epoxy resin composite.

In this manner, the prepared insulating epoxy resin composite was impregnated with glass fiber, and then this was compressed on the copper foil using a compressor to thereby manufacture to a substrate shown in FIG. 1A, and the copper foil of one side surface of the insulating substrate as shown in FIG. 1B was removed using nitric acid. As shown in FIG. 1C, the photoresist layer was formed on the copper foil of the other side surface of the insulating substrate, the photoresist layer was exposed and developed in the form of the first conductor pattern, the exposed and developed photoresist layer was subjected to electroplating, the remaining photoresist layer was removed using a stripping liquor (DPS-7300)(diethylene glycolmonomethyl ether of 35% to 55%, mono methyl formamide of 40% to 60%, amine of 2% to 7%, and other additives are included), and the exposed copper foil was subjected to soft-etching using sulfuric acid (H2SO4) to thereby be removed, thereby forming a first conductor pattern (see FIG. 1D).

As shown in FIG. 1E, a first insulating layer was formed on the first conductor pattern, using the insulating epoxy resin composite according to Example 1, and then a via-hole was formed using laser (not shown). A Cu seed layer having a thickness of about 2 μm was formed on the first insulating layer in a sputtering method, the photoresist layer was repeatedly formed on the seed layer, the photoresist layer was exposed and developed in the form of a second conductor pattern, the exposed and developed photoresist layer was subjected to electroplating, and the remaining photoresist layer and copper foil were removed in the above-described method, thereby forming a second conductor pattern (see FIG. 1F).

As shown in FIG. 1G, the second insulating layer was formed on the second conductor pattern to thereby manufacture a chip main body, and then a pair of external connection electrodes 80 and 81 was formed at both cross-sections of the chip main body to thereby manufacture the inductor of the present invention.

A dielectric loss and Q-factor of the inductor were measured, and based on the measurement result, the dielectric loss was 0.005 at 1 GHz, and the Q-factor was 27.2 at 2.4 GHz. An RF impedance material analyzer E4991A (manufactured by Agilent) as a tool for measuring the dielectric loss was used at 1 M to 3 GHz, and a dielectric material test fixture 16453A as a fixture was used. In addition, based on a measurement standard, 5 to 10 prepregs (a thickness of 0.4 mm to 1.0 mm) between Cu-foil of 18 μm were pressed and hardened in accordance with ASTM D709-01 using a V-press, an SPL was manufactured with a thickness of 0.4 mm to 1.0 mm, and a sample in the form of CCL was cut with a size of 3 cm×3 cm. Next, the copper foil was removed to record a thickness measurement value. The sample was inserted into the fixture using a device for measuring a dielectric loss, the thickness measurement value was input, and the dielectric loss value was measured at 1 GHz. The RF impedance material analyzer E4991A (manufactured by Agilent) acting as the tool for measuring the Q-factor was used at 1 M to 3 GHz, the fixture 16197 was used, the SPL (sample 0.8 mm×0.6 mm, thickness of 0.4 mm) was fixed to the fixture, a measurement frequency was set up at 2.4 GHz, and then measurement was carried out.

Accordingly, it has been found that the inductor of the present invention exhibited superior or equal properties compared to the existing ceramic substrate.

As described above, in the inductor according to the embodiments of the present invention, the insulating resin composite including polyester-based availability liquid crystal oligomer (LOC) is used for the insulating substrate, and therefore a coil of a fine pattern may be formed, and deformation of the coil does not occur due to smearing of an electrode in a printing process, or alignment deviation or a pressed electrode at the time of laminating and pressing, and nor does deformation of a coil occur due to contractive deformation at the time of firing because a firing process is not required. Therefore, stray capacity may be reduced to improve a Q-factor. In addition, since fluctuation and dispersion of inductance values are improved, the inductor having small variation may be effectively manufactured.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. An inductor comprising:
a chip main body that includes an insulating substrate, and a laminate in which a plurality of conductor patterns and insulating layers are alternately laminated on the insulating substrate, the laminate having a single coil in which the plurality of conductor patterns are connected to each other in series in the laminated direction thereof; and
a pair of external connection electrodes that are respectively provided on both side cross-sections of the chip main body, and in which an end of the single coil is connected to one of the pair of external connection electrodes and the other end thereof is connected to the other of the pair of external connection electrodes,
wherein the insulating substrate is composed of an insulating epoxy resin composite including liquid crystal oligomer (A) represented by the following chemical formula 1, epoxy resin (B), a hardener (C), and an inorganic filler (D). 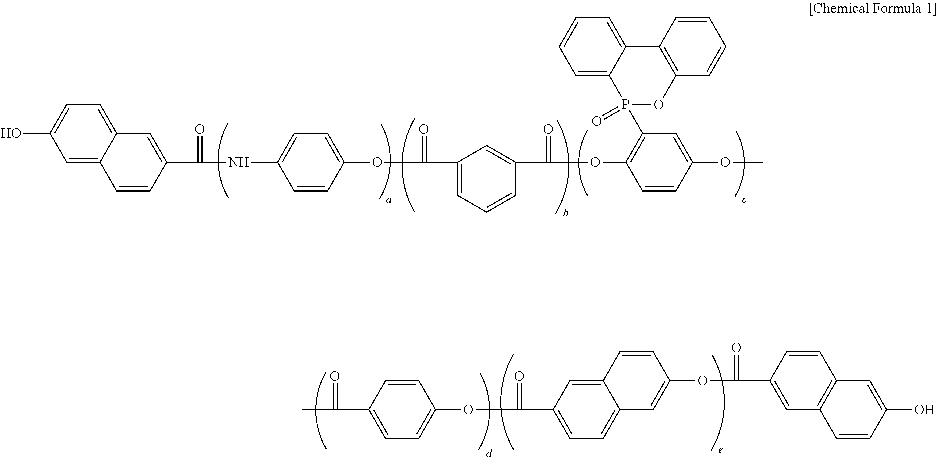
where, a, b, c, d, and e are the same or different integers of 1 to 100, and 4≦a+c+d+e≦103 is satisfied.

2. The inductor as set forth in claim 1, wherein the insulating layer is composed of the insulating epoxy resin composite including the liquid crystal oligomer represented by the following chemical formula 1, the epoxy resin, the hardener, and the inorganic filler. 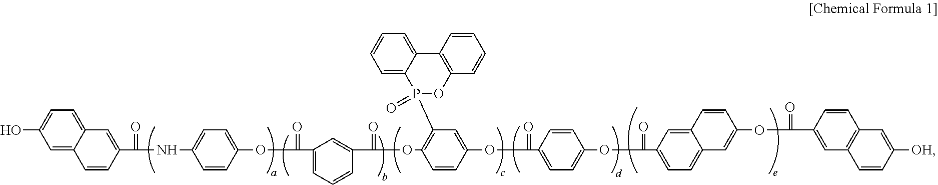
where, a, b, c, d, and e are the same or different integers of 1 to 100, and 4≦a+c+d+e≦103 is satisfied.

3. The inductor as set forth in claim 1, wherein a number average molecular weight of the liquid crystal oligomer is 2,500 to 6,500, and a molar ratio of amide in the liquid crystal oligomer is 12 to 30 mol %.

4. The inductor as set forth in claim 1, wherein the insulating resin composite includes 10 to 30 weight % of the liquid crystal oligomer, 5 to 20 weight % of the epoxy resin, 0.05 to 0.2 weight % of the hardener, and 50 to 80 weight % of the inorganic filler.

5. The inductor as set forth in claim 1, wherein the epoxy resin is bisphenol-F type epoxy resin represented by the following chemical formula 2.

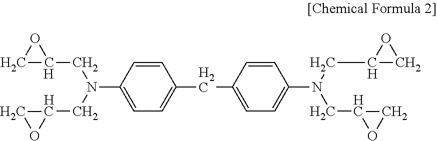 [SMILES: c1cc(N(CC2CO2)CC2CO2)ccc1Cc1ccc(N(CC2CO2)CC2CO2)cc1]

6. The inductor as set forth in claim 1, wherein the hardener is dicyanamide.

7. The inductor as set forth in claim 1, wherein the inorganic filler is one or more selected from a group of silica, alumina, barium sulfate, talc, clay, mica powder, aluminum hydroxide, magnesium hydroxide, calcium carbonate, magnesium carbonate, magnesium oxide, boron nitride, boric-acid aluminum, barium titanate, calcium titanate, magnesium titanate, bismuth titanate, titanium oxide, barium zirconate, and calcium zirconate.

8. The inductor as set forth in claim 1, wherein the insulating epoxy resin composite further includes one or more components selected from a group consisting of a hardening accelerator, a leveling agent, and a flame retardant.

9. A method of manufacturing an inductor, comprising:
providing an insulating substrate formed of an insulating epoxy resin composite that includes liquid crystal oligomer represented by the following chemical formula 1, epoxy resin, a hardener, and an inorganic filler;
hardening the insulating substrate by forming a copper foil on both side surfaces of the insulating substrate;
removing the copper foil at one side surface of the insulating substrate;
forming a photoresist layer on the copper foil of the other side surface of the insulating substrate, exposing and developing the formed photoresist layer in the form of a first conductor pattern, electrolytically plating the exposed and developed photoresist layer, and removing the remaining photoresist layer and copper foil to thereby form the first conductor pattern;
forming a first insulating layer on the first conductor pattern, and forming a via-hole;
forming a seed layer electrically connected through the via-hole formed on the first insulating layer;
forming a photoresist layer on the seed layer, exposing and developing the formed photoresist layer in the form of a second conductor pattern, electrolytically plating the exposed and developed photoresist layer, and removing the remaining photoresist layer and copper foil to thereby form the second conductor pattern;
manufacturing a chip main body by forming a second insulating layer on the second conductor pattern; and
providing a pair of external connection electrodes that are respectively provided on both side cross-sections of the chip main body, and in which an end of a single coil is connected to one of the pair of external connection electrodes and the other end thereof is connected to the other of the pair of external connection electrodes. 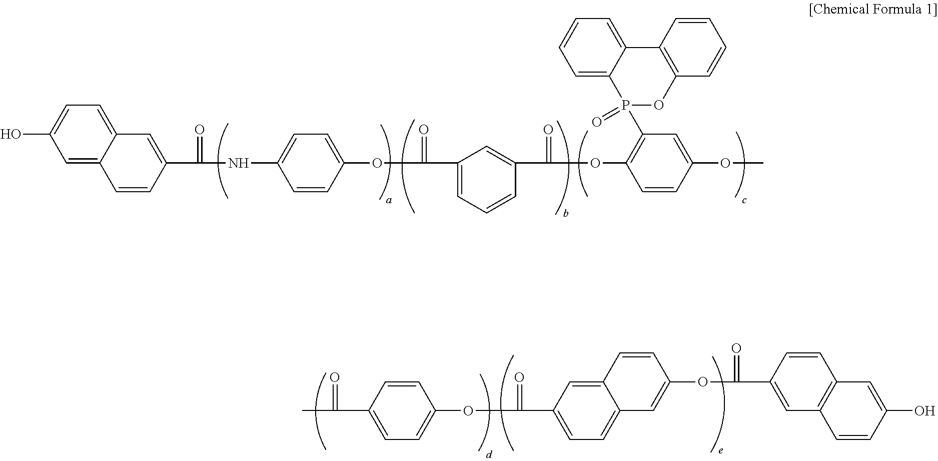
where, a, b, c, d, and e are the same or different integers of 1 to 100, and 4≦a+c+d+e≦103 is satisfied.

10. A method of manufacturing an inductor, comprising:
providing an insulating substrate formed of an insulating epoxy resin composite that includes liquid crystal oligomer represented by the following chemical formula 1, epoxy resin, a hardener, and an inorganic filler;
hardening the insulating substrate by forming a copper foil on both side surfaces of the insulating substrate;
removing the copper foil at the both side surfaces of the insulating substrate;
forming a first seed layer on one side surface of the insulating substrate;
forming a photoresist layer on the first seed layer, exposing and developing the formed photoresist layer in the form of a first conductor pattern, electrolytically plating the exposed and developed photoresist layer, and removing the remaining photoresist layer and copper foil to thereby form the first conductor pattern;
forming a first insulating layer on the first conductor pattern, and forming a via-hole;
forming a second seed layer electrically connected through the via-hole formed on the first insulating layer;
forming a photoresist layer on the second seed layer, exposing and developing the formed photoresist layer in the form of a second conductor pattern, electrolytically plating the exposed and developed photoresist layer, and removing the remaining photoresist layer and copper foil to thereby form the second conductor pattern;
manufacturing a chip main body by forming a second insulating layer on the second conductor pattern; and
providing a pair of external connection electrodes that are respectively provided on both side cross-sections of the chip main body, and in which an end of a single coil is connected to one of the pair of external connection electrodes and the other end thereof is connected to the other of the pair of external connection electrodes. 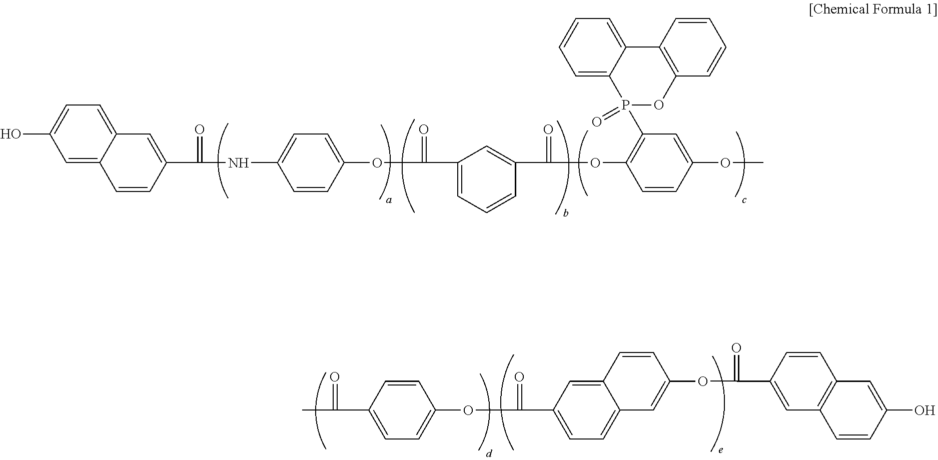
where, a, b, c, d, and e are the same or different integers of 1 to 100, and 4≦a+c+d+e≦103 is satisfied.

11. The method of manufacturing the inductor as set forth in claim 9, wherein the insulating layer is composed of the insulating epoxy resin composite including the liquid crystal oligomer represented by the following chemical formula 1, the epoxy resin, the hardener, and the inorganic filler. 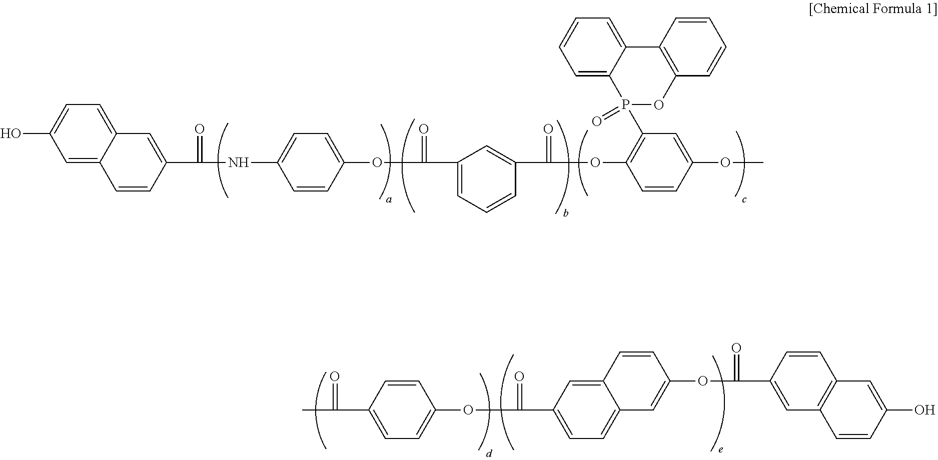
where, a, b, c, d, and e are the same or different integers of 1 to 100, and 4≦a+c+d+e≦103 is satisfied.

12. The method of manufacturing the inductor as set forth in claim 9, wherein a number average molecular weight of the liquid crystal oligomer is 2,500 to 6,500, and a molar ratio of amide in the liquid crystal oligomer is 12 to 30 mol %.

13. The method of manufacturing the inductor as set forth in claim 9, wherein the insulating resin composite includes 10 to 30 weight % of the liquid crystal oligomer, 5 to 20 weight % of the epoxy resin, 0.05 to 0.2 weight % of the hardener, and 50 to 80 weight % of the inorganic filler.

14. The method of manufacturing the inductor as set forth in claim 9, wherein the epoxy resin is bisphenol-F type epoxy resin represented by the following chemical formula 2.

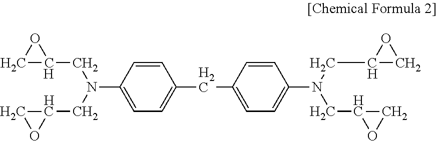 [SMILES: c1cc(N(CC2CO2)CC2CO2)ccc1Cc1ccc(N(CC2CO2)CC2CO2)cc1]

15. The method of manufacturing an inductor as set forth in claim 11, wherein the insulating resin composite includes 10 to 30 weight % of the liquid crystal oligomer, 5 to 20 weight % of the epoxy resin, 0.05 to 0.2 weight % of the hardener, and 50 to 80 weight % of the inorganic filler.

16. The method of manufacturing the inductor as set forth in claim 9, wherein the insulating substrate is formed in such a manner that the insulating epoxy resin composite is impregnated with glass fiber.
